(19) United States
(12) Patent Application Publication
(10) Pub. No.: US 2016/0152109 A1
(43) Pub. Date: Jun. 2, 2016

(54) DEVICE FOR COLLECTING BATTERY GAS OF VENTILATING SEAT AND METHOD FOR THE SAME

(71) Applicant: HYUNDAI MOTOR COMPANY, Seoul (KR)

(72) Inventors: Hee Tae YANG, Seoul (KR); Suk Hyung KIM, Gunpo-si (KR); Dong Gun KIM, Gunpo-si (KR)

(21) Appl. No.: 14/696,272

(22) Filed: Apr. 24, 2015

(30) Foreign Application Priority Data
Nov. 27, 2014 (KR) 10-2014-0167583

(51) Int. Cl. B60H 1/00; H01M 10/48; H01M 10/625; H01M 2/12; H01M 10/613

(52) U.S. Cl. CPC B60H 1/008; H01M 2/12; H01M 10/613; H01M 10/625; H01M 10/48; B60H 1/00835; H01M 2220/20

(57) ABSTRACT

A device for collecting battery gas of a ventilating seat includes a ventilating seat having a ventilating fan and a ventilating duct to perform ventilation. A battery is disposed under the ventilating seat to supply electricity to a vehicle. A gas collecting pack is disposed in the ventilating duct to collect electrolyte gas generated from the battery.

### CROSS-REFERENCE TO RELATED APPLICATION

This application is based on and claims the benefit of priority to Korean Patent Application No. 10-2014-0167583, filed on Nov. 27, 2014 in the Korean Intellectual Property Office, the disclosure of which is incorporated herein in its entirety by reference.

### TECHNICAL FIELD

The present disclosure relates to a device for collecting battery gas of a ventilating seat and a method for the same, and more particularly, to a device for collecting battery gas of a ventilating seat and a method for the same capable of securing safety by collecting electrolyte gas leaked from a battery.

### BACKGROUND

A vehicle has a battery therein. For example, a hybrid vehicle uses a 48V lithium ion battery instead of the existing 12V lead storage battery to improve fuel efficiency.

The 48 V lithium ion battery system is basically configured to include battery/relay/controller/cooling fan and as a mounting position thereof, tire well/trunk/lower portion of passenger seat/lower power of driver's seat/glove box, and the like are considered.

A mounting position of the battery is defined as the lower portion of the seat due to advantages of impact safety and cooling performance of the battery.

However, since the lower portion of the seat is close to a driver, when electrolyte gas is leaked from the battery, the electrolyte gas may be directly exposed to the driver and therefore, the safety of the battery may be reduced.

### SUMMARY

The present disclosure has been made to solve the above-mentioned problems occurring in the prior art while advantages achieved by the prior art are maintained intact.

An aspect of the present inventive concept provides a device for collecting battery gas of a ventilating seat and a method for the same capable of securing safety by collecting electrolyte gas leaked from a battery, which is mounted under a ventilating seat using an inner space of the ventilating seat and a ventilating fan.

According to an exemplary embodiment of the present inventive concept, a device for collecting battery gas of a ventilating seat includes a ventilating seat have a ventilating fan and a ventilating duct to perform ventilation. A battery is disposed under the ventilating seat to supply electricity to a vehicle. A gas collecting pack is disposed in the ventilating duct to collect electrolyte gas generated from the battery.

An inlet part of the battery may have a cooling fan and an outlet part thereof interlocks to the ventilating fan and the ventilating duct.

The battery may include a gas detection sensor detecting a generation of the electrolyte gas.

A connection portion between the ventilating duct and the gas collecting pack may be rotatably provided with a door to selectively open and close the ventilating duct or the gas collecting pack upon generation of the electrolyte gas.

The door part may include a door driver mounted at the connection portion between the ventilating duct and the gas collecting pack. A control door is rotatably mounted at the door driver to selectively open and close the ventilating duct or the gas collecting pack.

The gas detection sensor may be connected to a controller which is mounted in the vehicle to operate the door part, control the number of stages of the cooling fan and the ventilation fan, and may turn on a warning light and displays a warning word.

According to another exemplary embodiment of the present disclosure, a method for collecting battery gas of a ventilating seat includes detecting electrolyte gas generated from a battery. Whether the detected electrolyte gas concentration is equal to or more than a predetermined concentration is determined. A control door is rotated toward a ventilating duct of a ventilating seat if it is determined that the concentration of the electrolyte gas is equal to or more than the predetermined concentration to move the electrolyte gas to a gas collecting pack.

The method may further include displaying a leakage warning of harmful gas and a driver escape guidance word if it is determined that the electrolyte gas moves to the gas collecting pack.

The method may further include operating a cooling fan included in the battery and a ventilating fan included in the ventilating seat at the maximum number of stages.

The method may further include determining whether a driver gets off the vehicle.

The method may further include stopping the cooling fan of the battery and the cooling fan of the ventilating seat if it is determined that the driver gets off the vehicle.

The method may further include rotating the control door to the gas collecting pack.

The method may further include performing the step of stopping the stopping the cooling fan if an operation time of the maximum number of stages of the fan exceeds a predetermined time when the driver does not yet get off the vehicle and performing the step of operating the cooling fan if the operating time is equal to or less than the predetermined time by determining that the operation time of the maximum number of stages of the fan exceeds a predetermined time.

### BRIEF DESCRIPTION OF THE DRAWINGS

The above and other objects, features, and advantages of the present disclosure will be more apparent from the following detailed description taken in conjunction with the accompanying drawings.

FIG. 1 is a diagram illustrating a device for collecting battery gas of a ventilating seat according to an exemplary embodiment of the present inventive concept.

FIG. 2 is a diagram illustrating a state in which a ventilating duct is opened in the device for collecting battery gas of a ventilating seat according to an exemplary embodiment of the present inventive concept.

FIG. 3 is a diagram illustrating a state in which a gas collecting pack is opened in the device for collecting battery gas of a ventilating seat according to an exemplary embodiment of the present inventive concept.

FIG. 4 is a flow chart illustrating a method for collecting battery gas of a ventilating seat according to an exemplary embodiment of the present inventive concept.

### DETAILED DESCRIPTION

Exemplary embodiments of the present inventive concept will be described in detail with reference to the accompanying drawings.

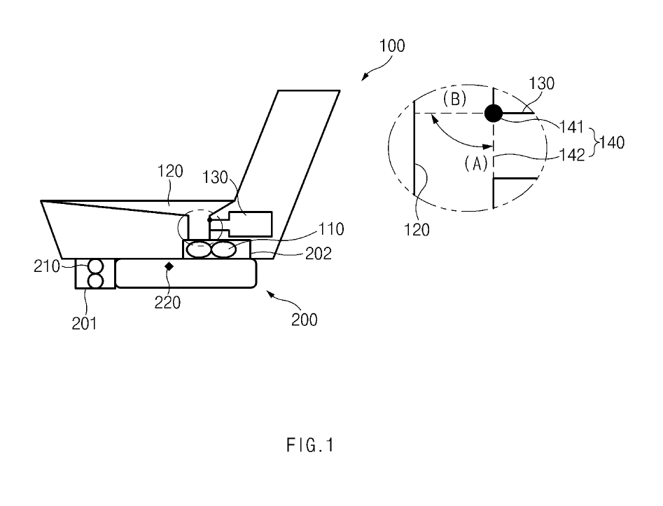

As illustrated in FIGS. 1 to 3, a device for collecting battery gas of a ventilating seat according to an exemplary embodiment of the present inventive concept includes a ventilating seat 100 in which ventilation may be made. A battery 200 is disposed under the ventilating seat 100, and a gas collecting pack 130 collects electrolyte gas.

As illustrated in FIG. 1, the ventilating seat 100 is mounted in a vehicle to supply cool and hot air of a blower, thereby performing a temperature control.

In this case, the ventilating seat 100 includes a ventilating fan 110 controlling ventilation and a ventilating duct 120 in which the ventilation may be made.

The battery 200 is mounted under the ventilating seat 100 to supply electricity to the vehicle.

The gas collecting pack 130 is mounted in the ventilating duct 120 of the ventilating seat 100 to collect the electrolyte gas generated from the battery 200.

In this case, an inlet part 201 which is an inlet of the battery 200 has a cooling fan 210 to cool the battery 200 and an outlet part 202 which is an outlet thereof communicates with the ventilating fan 110 and the ventilating duct 120 of the ventilating seat 100 to move the electrolyte gas to the ventilating duct 120 by operating the ventilating fan 110 when electrolyte gas is generated from the battery 200 and ultimately discharge the electrolyte gas to the gas collecting pack 130.

The inlet part 201 and the outlet part 202 of the battery 200 may has a plurality of fans to improve a collecting speed while preventing an extremely small amount of electrolyte gas from being leaked through the ventilating duct 120.

Further, the battery 200 may have a gas detection sensor 220 which detects generation of the electrolyte gas.

A connection portion between the ventilating duct 120 and the gas collecting pack 130 is provided with a rotatable door 140. In this case, the rotatable door 140 may selectively rotate depending on whether the electrolyte gas is generated to close the gas collecting pack 130 and open the ventilating duct 120 or open the gas collecting pack 130 and close the ventilating duct 120.

In this case, the door 140 includes: a door driver 141 configured to be mounted at the connection portion between the ventilating duct 120 and the gas collecting pack 130; and a control door 142 rotatably mounted at the door driver 141 to selectively open and close the ventilating duct 120 or the gas collecting pack 130.

The gas detection sensor 220 may be connected to a controller (not shown) which is mounted in the vehicle to operate the door part 140 and may control the number of stages of the cooling fan 210 and the ventilation fan 110 to control a collecting speed.

A warning light may be turned on and warning labels may be displayed to inform a driver of leakage of the electrolyte gas, thereby securing time for the driver to stop the vehicle and escape from the vehicle.

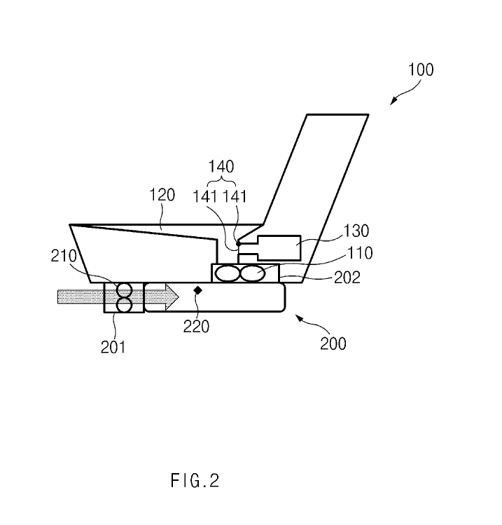

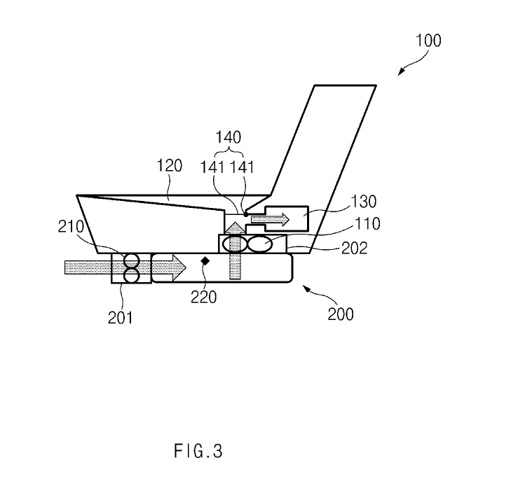

That is, according to the exemplary embodiment of the present inventive concept, as illustrated in FIG. 2, when the battery 200 is in a normal state (non-detection of the electrolyte gas), the control door 142 of the door part 140 maintains state (A) of FIG. 1 to close the gas collecting pack 130 and open the ventilating duct 120, thereby implementing the ventilation operation of the ventilating seat and as illustrated in FIG. 3. When the electrolyte gas leaked from the battery 200 is detected, the control door 142 rotates as illustrated in B of FIG. 1 to open the gas collecting pack 130 and close the ventilating duct 120, thereby collecting the electrolyte gas into the gas collecting pack 130 while preventing the electrolyte gas from moving to the ventilating seat 100.

When the electrolyte gas is generated, the warning light is turned on and a vehicle escape warning word is displayed to inform the driver of the leakage of the electrolyte gas, and the cooling fan 210 of the battery 200 and the ventilating fan 110 of the ventilating seat 100 are operated at the maximum number of stages to improve the collecting speed of the electrolyte gas.

In this case, the gas collecting pack 130 is full, and thus, when the electrolyte gas may be no more collected or the driver escapes from the vehicle, the operation of the cooling fan 210 and the ventilating fan 110 stops and the control door 142 again rotates from (B) to (A).

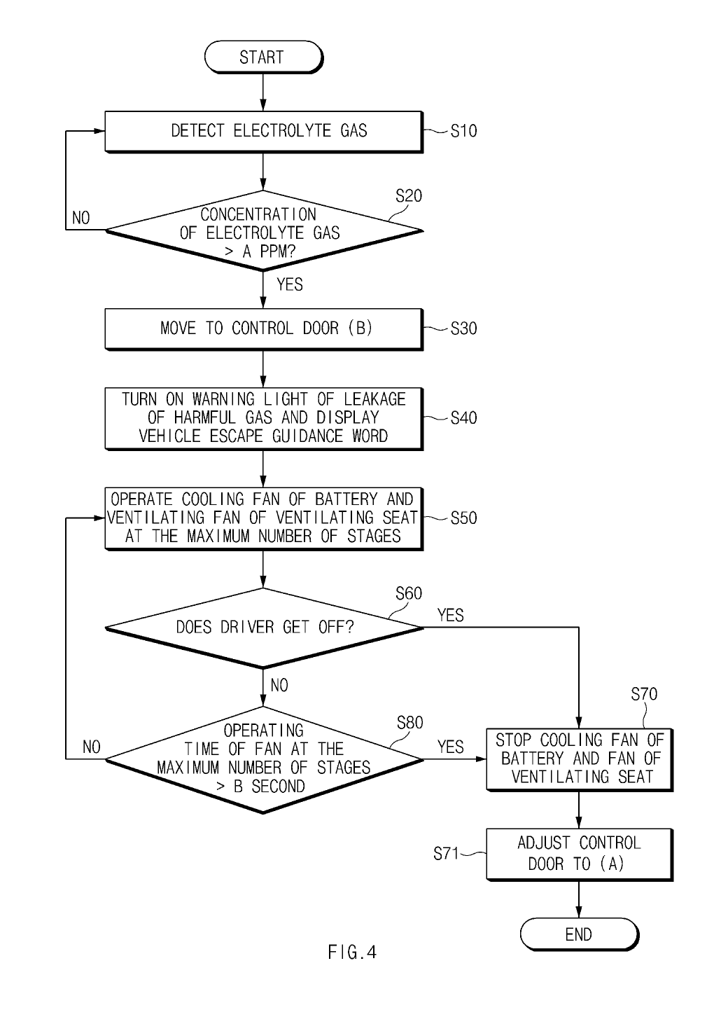

As illustrated in FIG. 4, the method for collecting battery gas of a ventilating seat according to an exemplary embodiment of the present inventive concept includes detecting the electrolyte gas (S10), determining a concentration of the electrolyte gas (S20), and collecting the electrolyte gas into the gas collecting pack 130. A content of the device for collecting battery gas of the ventilating seat 100 will be described with reference to FIG. 1.

The electrolyte gas generated from the battery 200 is detected in step S10.

Whether the electrolyte gas concentration detected in the first step (S10) is equal to or more than a predetermined concentration is determined in step S20. If it is determined that the electrolyte gas concentration is equal to or more than the predetermined concentration, it is determined that the electrolyte gas is harmful. Therefore, the process proceeds to the subsequent step. If it is determined that the electrolyte gas concentration is less than the predetermined concentration, the process proceeds to the step S10 to again detect whether gas is the electrolyte gas.

If it is determined in the second step (S20) that the concentration of the electrolyte gas is equal to or more than the predetermined concentration, the electrolyte gas is harmful gas, and therefore the control door 142 rotates to the ventilating duct 120 (B of FIG. 1) of the ventilating seat 100 to move the electrolyte gas to the gas collecting pack 130 thus to collect the electrolyte gas in step S30.

In this case, since the harmful gas is generated when the electrolyte gas moves to the gas collecting pack 130 in step S30, the leakage warning of harmful gas and a driver escape guidance word on the vehicle is performed in step S40.

Further, after step S40, the cooling fan 210 included in the battery 200 and the ventilating fan 110 included in the ventilating seat 100 are operated at the maximum number of stages is performed to improve the collecting speed of the electrolyte gas in step S40.

After the step S50, whether the driver gets off the vehicle is determined in step S60.

If it is determined that the driver gets off the vehicle to secure the driver safety, the process proceeds to stopping the cooling fan 210 of the battery 200 and the ventilating fan 110 of the ventilating seat 100 in step S70.

Further, after step S70, the process proceeds to opening the ventilating duct 120 by rotating the control door 142 to the gas collecting pack 130 (A of FIG. 1) in step S71.

By determining in step S60 whether an operating time of the maximum number of stages of the cooling fan 210 and the ventilating fan 110 exceeds a predetermined time when the driver does not yet get off the vehicle, step S80 proceeds to step S70 if it is determined that the operating time exceeds the predetermined time to stop the cooling fan 210 of the battery 200 and the ventilating fan 110 of the ventilating seat 100 and if it is determined that the operating time is equal to or less than the predetermined time, proceeds to the step S50 to operate the cooling fan 210 included in the battery 200 and the ventilating fan 110 included in the ventilating seat 100 at the maximum number of stages, thereby improving the collecting speed of the electrolyte gas.

As described above, according to the present disclosure, it is possible to minimize the specifications of the cooling fan of the battery by allowing the ventilating fan of the ventilating seat to assist the battery cooling, improve the marketability by effectively collecting the leaked electrolyte gas to prevent the electrolyte gas from being leaked to the inlet or the outlet, and improve the safety by securing enough time for the driver to stop the vehicle and escape from the vehicle as soon as the driver is informed of the leakage of the electrolyte gas.

As described above, although the present inventive concept has been described with reference to exemplary embodiments and the accompanying drawings, it would be appreciated by those skilled in the art that the present disclosure is not limited thereto but various modifications and alterations might be made without departing from the scope defined in the following claims.

What is claimed is:

1. A device for collecting battery gas of a ventilating seat, comprising:
the ventilating seat having a ventilating fan and a ventilating duct;
a battery disposed under the ventilating seat; and
a gas collecting pack disposed in the ventilating duct to collect gas generated from the battery.

2. The device according to claim 1, wherein an inlet part of the battery has a cooling fan, and an outlet part thereof interlocks to the ventilating fan and the ventilating duct.

3. The device according to claim 2, wherein the battery includes a gas detection sensor detecting generation of the gas.

4. The device according to claim 3, wherein a connection portion between the ventilating duct and the gas collecting pack is rotatably provided with a door to selectively open and close the ventilating duct or the gas collecting pack upon the generation of the gas.

5. The device according to claim 4, wherein the door includes:
a door driver mounted at the connection portion between the ventilating duct and the gas collecting pack; and
a control door rotatably mounted at the door driver to selectively open and close the ventilating duct or the gas collecting pack.

6. The device according to claim 4, wherein the gas detection sensor is connected to a controller which is mounted in the vehicle to operate the door, controls the number of stages of the cooling fan and the ventilation fan, and turns on a warning light and displays a warning word.

7. A method for collecting battery gas of a ventilating seat, the method comprising steps of:
detecting gas generated from a battery;
determining whether a concentration of the detected gas is equal to or more than a predetermined concentration; and
rotating a control door toward a ventilating duct of the ventilating seat when it is determined that the concentration of the electrolyte gas is equal to or more than the predetermined concentration to move the electrolyte gas to a gas collecting pack.

8. The method according to claim 7, further comprising:
displaying a leakage warning of gas and a driver escape guidance word when it is determined that the gas moves to the gas collecting pack.

9. The method according to claim 8, further comprising:
operating a cooling fan and a ventilating fan at the maximum number of stages.

10. The method according to claim 9, further comprising:
determining whether a driver gets off a vehicle.

11. The method according to claim 10, further comprising:
stopping the cooling fan of the battery and the ventilating fan of the ventilating seat if it is determined that the driver gets off the vehicle.

12. The method according to claim 11, further comprising:
rotating the control door toward the gas collecting pack.

13. The method according to claim 12, further comprising:
performing the step of stopping the cooling fan when an operation time of the maximum number of stages of the cooling fan exceeds a predetermined time when the driver does not yet get off the vehicle and performing the step of operating the cooling fan if the operating time is equal to or less than the predetermined time, by determining that the operation time exceeds the predetermined time.
